(19) United States
(12) Patent Application Publication
(10) Pub. No.: US 2008/0253566 A1
(43) Pub. Date: Oct. 16, 2008

(54) COMMUNICATIONS SYSTEM, COMMUNICATIONS APPARATUS AND METHOD, AND COMPUTER PROGRAM

(75) Inventor: Isao Hidaka, Tokyo (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/100,806

(22) Filed: Apr. 10, 2008

(30) Foreign Application Priority Data
Apr. 16, 2007 (JP) 2007-106946

(51) Int. Cl. H04L 9/00

(52) U.S. Cl. 380/255; 380/44

(57) ABSTRACT

Disclosed herein is a communications system configured to execute data transmission by use of a first transmission media and a second transmission media that are different from each other in security level, a communications apparatus on a transmitting side dividing transmission data into first transmission data and second transmission data that are transmitted via said first transmission media and said second transmission media, respectively, encrypting said first transmission data by use of at least a part of said second transmission data, transmitting the first and second transmission data, a communications apparatus on a receiving side receiving said first and second transmission data decrypting the encrypted first transmission data by use of at least a part of said second transmission data, and reconfiguring original transmission data from said first transmission data and said second transmission data.

### CROSS REFERENCES TO RELATED APPLICATIONS

The present application claims priority to Japanese Patent Application JP 2007-106946 filed in the Japan Patent Office on Apr. 16, 2007, the entire contents of which is being incorporated herein by reference.

### BACKGROUND

The present application relates to a communications system, a communications apparatus and method, and a computer program that are configured to relay data to a destination of data transmission by use of a plurality of bridge apparatuses and, more particularly, to a communications system, a communications apparatus and method, and a computer program that are configured to relay data transmission by use of bridge apparatuses connected by two or more transmission media.

More specifically, the present application relates to a communications system, a communications apparatus and method, and a computer program that are configured to execute data transmission by the simultaneous use of both secure transmission media and insecure transmission media and, more particularly, to a communications system, a communications apparatus and method, and a computer program that are configured to also securely transmit transmission data distributed to insecure transmission media in the same manner as the transmission data distributed to secure transmission media.

Recently, the use of information providing services built on wide area networks represented by the Internet has been gaining popularity, giving people more and more chances of downloading mass data files and distributing moving image stream data. Reception of these services by families may be executed in a form in which a bridge apparatus, such as a router, is connected to a backbone network, such as the Internet, through wide-band wired communication, such as ADSL (Asynchronous Digital Subscriber Line), and downloaded data is transferred from the bridge apparatus to an information terminal, such as a personal computer (PC), via LAN (Local Area Network) arranged in a home.

Referring to FIG. 13, there is shown an exemplary configuration of a communications system arranged for using the Internet in home. In a house, a bridge apparatus 103, such as a router, is arranged. This bridge apparatus 103 is connected to a server 101 providing an information providing source via an external network 102, such as the Internet. Also, in a home, a LAN, such as Ethernet (registered trademark), is arranged, to which a communications terminal 105, such as a PC, is connected. An IP (Internet Protocol) is installed on the display block 150 to enable the downloading of data from the server 101 on the Internet for browsing on a browser screen, for example. It should be noted that the IP is specified in 791 of RFC (Request For Comment) issued by IETF (Internet Engineering Task Force).

Recently, wireless LANs have been quickly gaining popularity. With wireless LANs, a bridge apparatus is connected to a backbone network, such as the Internet and at the same time, functions as an access point to provide a service area to a wireless communications terminal. The wireless LAN allows flexible Internet connection and replaces existing wired LANs, providing Internet connection means also in public spaces, such as hotels, airport lounges, railroad stations, and cafes.

Referring to FIG. 14, there is schematically shown an exemplary configuration of a communications system based on a wireless LAN. In the figure, a wireless bridge apparatus 203 has a network interface capability of connection with a server 201 via a wired transmission line 202 and a wireless LAN access point for wireless terminals, thereby transmitting data downloaded from the server 201 to a wireless transmission line 204. Another wireless bridge apparatus 205 functions as a terminal station to be connected to the access point, for example, transferring data received via the wireless transmission line 204 to an information terminal 207, such as a PC, via a wired transmission line 206.

Technologies for arranging a network in a building include PLC (Power Line Communication) in which a device having a communications capability that receives power via a power line superimposes a communications signal on the power line to communicate with another device having a similar capability, for example. The power line communication allows communication between devices arranged in rooms each having an AC receptacle and has no restriction on the location of the mate device in the room having an AC receptacle. PLC-based communications systems can realize high-speed communication of over 100 Mbps by use of an existing power line without newly arranging a communications cable.

FIG. 15 shows an exemplary configuration of a communications system with a part of a wired communication path between a server 301 and a communications terminal 307, such as a PC, replaced by a power line transmission path 304 by use of a set of PLC bridge apparatuses 303 and 305. In the example shown. The PLC bridge apparatus 303 has a network interface capability of connecting with the server 301 via a wired transmission path 302 and a PLC interface capability. The PLC bridge apparatus 303 is connected to another PLC bridge apparatus 305 via a power line transmission path 304. The PLC bridge apparatus 305 relays data to an end information terminal 307, such as a PC, via a wired transmission path 306.

In the example shown in FIG. 15, the wired transmission path 302 or the wired transmission path 306 is a wired LAN typified by Ethernet (registered trademark). For example, a method is proposed in which, in order to efficiently pass packets between a PLC LAN and a network technology apparatus different therefrom, the packets received by an edge of a PLC network are connected by a PLC MAC bridge (refer to, for example, Japanese Patent Laid-open No. 2005-39814, hereinafter referred to as Patent Document 1).

It should he noted that, because data communication involves a problem of transmission media's being intercepted by a third party, security measures has to be taken in the transmission and reception of important data.

The security system of a particular communications system depends on the transmission media used. The wired communication has a higher security level than that of the wired communication. If there is means of accessing communication cables, it is difficult to intercept the data flowing in transmission media. For example, the data that is transmitted by Ethernet or the above-mentioned PLC arranged in a home may not be intercepted unless getting in the home. In contrast, the wireless communication propagates data in the air and the transmission media used is not directional, thereby giving a third party an easy chance of data interception. For example, the data that is transmitted by means of wireless transmission media in a home can be intercepted from the outside.

With many communications systems, security measures are taken in accordance with the security level of the transmission media used. A typical example of security technologies is encryption. Encrypting data before transmission makes it difficult to easily understand the contents of data that may be intercepted while being transmitted along the transmission media.

For example, with IEEE 802.11, a representative standard of wireless LAN, security means based on WEP (Wired Equivalent Privacy) as an optional standard is introduced. WEP is a capability of realizing a security level equivalent to that of the wired transmission media by encrypting the wireless transmission media based on a common key encryption algorithm (refer to, for example, Japanese Patent Laid-open No. 2001-345819, hereinafter referred to as Patent Document 2). To be more specific, WEP uses WEP PRNG (Pseudo Random Number Generator) of RC (Rivest Cipher) 4 to use the lower 40 bits of the 64 bits generated for every packet as an encryption key. Also available is a product that uses a 104-bit key for enhanced security.

Encryption of transmission media demands an encryption key. Namely, in encrypting transmission data, the transmission side uses a encryption key; in decrypting the encrypted reception data, the receiving side uses a decryption key. In many cases, a common key encryption algorithm is used in which the transmission side and the reception side use a key common to both side. A separate scheme for sharing a key between the transmission side and the reception side is demanded before executing data communication. In the case of wireless LANs, the user sets key data to both the devices of the transmission side and the reception side beforehand.

On the other hand, a communications system is known in which data transmission is made faster by the simultaneous use of multiple transmission media. For example, a communications system is proposed in which the high-speed transmission is realized by the simultaneous use of two frequency bands of 2.4 GHz and 5 GHz (refer to, for example, Japanese Patent No. 3838237. hereinafter referred to as Patent Document 3).

In the above-mentioned related-art technologies, two or more wireless transmission media are composite; however, the inventors hereof consider that substantially the same high-speed transmission effects can be attained by the combination of wireless transmission media and wired transmission media.

The above-mentioned composite approach involves a problem that the different transmission media demand different security levels, which in turn demands different security measures, thereby complicating communications systems based on different transmission media. Namely, while the wireless transmission media essentially demand encryption, the wired transmission media do not demand encryption. Therefore, communications systems based on the combination of wireless and wired transmission media demands the setting and management of cryptographic keys as a whole although the wired transmission media section does not demand encryption.

### SUMMARY

The subject matter of the present application addresses the above-identified and other problems associated with related-art methods and apparatuses and solves the addressed problems by providing a communications system, a communications apparatus and method, and a computer program that are configured to simultaneously use a plurality of transmission media to enhance the speed of data transmission according to an embodiment.

It is desirable to provide a communication system, a communication apparatus and method, and a computer program that are configured to execute data transmission by use simultaneous use of secure transmission media and insecure transmission media.

It is also desirable to provide a communication system, a communication apparatus and method, and a computer program that are configured to also securely transmit transmission data distributed to insecure transmission media in substantially the same manner as the transmission data distributed to secure transmission media.

According to a first embodiment thereof, there is provided a communications system configured to execute data transmission by use of a first transmission media and a second transmission media that are different from each other in security level. A communications apparatus on a transmitting side divides transmission data into first transmission data and second transmission data that are transmitted via the first transmission media and the second transmission media, respectively, encrypts the first transmission data by use of at least a part of the second transmission data, transmits the encrypted first transmission data to the first transmission media, and transmits the second transmission data to the second transmission media in an unencrypted form. A communications apparatus on a receiving side receiving the encrypted first transmission data via the first transmission media, receives the second transmission data via the second transmission media, decrypts the encrypted first transmission data by use of at least a part of the second transmission data, and reconfigures original transmission data from the first transmission data and the second transmission data

It should also be noted that term “system” as used herein denotes a logical set of a plurality of component units and these component units are not necessary accommodated in a same housing.

The communications system associated with the present application is configured by two or more transmission media, such as a wireless transmission path and a power line transmission path, for example, the source and destination communications apparatuses being connected each other by use of a hybrid network bridge apparatus having a hybrid network bridge capabilities.

This hybrid network bridge apparatus divides data to be transmitted and alternately transmits the divided data to the wireless transmission path and the power line transmission path. Therefore, depending on transmission forms and communications states, these transmission media are combined or selected, thereby realizing high-speed communication with efficient transmission while ensuring the quality of communication. Namely, the communication system according to the present application is significantly higher in communications speed than that of communications systems based on only one transmission media.

Meanwhile, in data communication, there is a problem that transmission media are intercepted by a third party, so that security measures must be taken when transmitting and receiving important data. Generally, encryption technologies are applied in accordance with the security level of each transmission media to maintain the secrecy of transmission data. With a communications system that simultaneously uses two or more transmission media, the transmission media have different security levels, in which the wireless transmission path demands encryption while the power line transmission path does not.

Encryption of transmission media demands the use of an encryption key and separately demands a scheme in which the transmitting side and the receiving side share a common key. In a communications system based on a combination of a wired transmission media and a wireless transmission media, the wired transmission media need not encryption, but, as a whole system, the setting of keys and the management thereof are required.

The communications system according to an embodiment is configured by combining a first transmission media, such as a wireless LAN that is low in security level and therefore demands encryption for data secrecy and a second transmission media, such as a power line path or other wired communication that is high in security level and therefore does not demand encryption in most cases.

With the communications apparatus on the transmitting side, in dividing transmission data into first transmission data and second transmission data to be transmitted via a first transmission media and a second transmission media, respectively, an encryption key is generated by use of at least a part of the second transmission data, and the first transmission data is encrypted by use of this generated encryption key. Next, the encrypted first transmission data is transmitted to the first transmission media and the second transmission data is transmitted to the second transmission media in an unencrypted form. Therefore, data transmission can be executed in a secure manner in both the first and second transmission media.

On the other hand, with the communications apparatus on the receiving side, the encrypted first transmission data is received via the first transmission media and the second transmission data via the second transmission media Then, by use of at least a part of the second transmission data, a decryption key is generated by use of a same algorithm as that used when the encryption was generated on the transmitting side and the encrypted first transmission data is decrypted by use of the generated decryption key in accordance with a same encryption algorithm as that used on the transmitting side. When the original transmission data is reconfigured from the first and second transmission data, the reconfigured data is transmitted to an upper application.

Encryption of transmission media demands the sharing of a key between the transmitting and receiving sides. According to the communications system practiced in an embodiment, an encryption key is generated on the basis of the second transmission data transmitted via the secure second transmission media, so that the user need not execute special operations and methods for key sharing, such as setting key data to both the transmitting and receiving devices in advance.

In the communications system according to an embodiment, the encryption key for encrypting the insecure first transmission media can be changed for even packet. With a related-art communications systems in which one key is used for comparatively long period, it is possible for this key to be broken by so-called brute force (or round-robin) attack. However, according to the embodiment, if the key for one packet is broken, other packets remain secure, thereby neutralizing such attacks.

The communications system practiced as one embodiment of the application is generally the same as related-art communications systems except that the data part is encrypted. Therefore, compatibility can be maintained with related-art insecure networks, thereby making it practicable to configure devices that simultaneously communicate with legacy devices.

Also, with the communications system according to an embodiment, the processing of encryption and decryption to be executed on the transmitting and receiving sides can he simplified.

To be more specific, the communications apparatus on the transmitting side can simply encrypt the first transmission data by executing an exclusive OR operation with at least a part of the second transmission data without generating an encryption key by use of the second transmission data. In this case, the communications apparatus on the receiving side can decrypt the encrypted first transmission data received via the first transmission media by executing an exclusive OR operation with at least a part of the second transmission data received via the second transmission media

Application of an exclusive OR operation, instead of the encryption processing, such as AES, allows encryption processing with very small amount of computation. For example, this eases the application to incorporated devices having low computation power.

In addition, with the communications system practiced as one embodiment of the present application, the first transmission media can be made secure regardless of the data length in dividing transmission data into the first and second transmission data on the transmitting side.

For example, if transmission data is distributed so as to make uniform the transmission times in these transmission media, it is possible that the data length of the last half of the second data becomes short depending on the communications quality of each transmission media. On the other hand, because the security strength of encryption key depends on the length of input data into a key generator, the key strength may be lowered depending on the data length in a system in which encryption key is generated by use of the second transmission data.

In contrast, with the communications system practiced as one embodiment of the present application, the communications apparatus on the transmitting side generates given data, adds this given data to the second transmission data, and generates an encryption key by configuring the input data satisfying the length enough for maintaining encryption strength, thereby maintaining encryption strength regardless of the data length in the division of transmission data.

Given data used for supplementing the length of input data is also necessary for generating a decryption key for the decryption processing on the receiving side. Therefore, the communications apparatus on the transmitting side transmits the generated given data to the communications apparatus on the receiving side via the secure second transmission media. Then, the communications apparatus on the receiving side receives the encrypted first transmission data via the first transmission media and receives the second transmission data and the given data via the second transmission media and generates a decryption key on the basis of the data obtained by adding the given data to the second transmission data, thereby decrypting, by use of the generated decryption key, the encrypted first transmission data received via the first transmission media.

Also, if same data continues, the possibility of guessing the encryption key used to encrypt that data becomes high, presenting a danger of weakening the encrypted transmission media. Therefore, a method is proposed in which given data generated by the transmitting side is used not as the supplement to the length of input data into the key generator as described above, but as an initialization vector for initializing the encryption processing.

In the above-mentioned case, the communications apparatus on the transmitting side generates an encryption key by use of at least a part of the second transmission data and generates an initialization vector, thereby encrypting the first transmission data after the initialization by use of the initialization vector. Then, the communications apparatus transmits the encrypted first transmission data to the first transmission media and transmits the second transmission data and the initialization vector to the second transmission media in an unencrypted form.

The communications apparatus on the receiving side receives the encrypted first transmission data via the first transmission media and receives the second transmission data and the initialization vector via the second transmission media. Then, the communications apparatus on the receiving side generates a decryption key by use of at least a part of the second transmission data received via the second transmission media and decrypts the encrypted first transmission data received via the first transmission media by use of this decryption key after the initialization by use of the initialization vector.

With the communications system according to an embodiment, transmission packets have different encryption keys for encrypting the first transmission media that is not secure, so that code breaking attempts, such as a brute force method, can be almost frustrated. In addition, appropriately switching between initialization vectors makes code breaking attempts more difficult, thereby ensuring secrecy for the case in which same data continue.

According to a second embodiment thereof, there is provided a computer program written in a computer-readable form so as to execute, on a computer, processing of transmission of data to a first transmission media and a second transmission media that are different from each other in security level. This computer programs has steps of distributing transmission data to first transmission data and second transmission data to be transmitted via the first transmission media and the second transmission media; encrypting the first transmission data by use of at least a part of the second transmission data; and transmitting the encrypted first transmission data to the first transmission media and transmit the second transmission data to the second transmission media in an encrypted form.

According to a third embodiment thereof, there is provided a computer program written in a computer-readable form so as to execute, on a computer, processing of transmission of data to a first transmission media and a second transmission media that are different from each other in security level, wherein a communications apparatus on a transmitting side divides transmission data into first transmission data and second transmission data to be transmitted via the first transmission media and the second transmission media, respectively, encrypts the first transmission data by use of at least a part of the second transmission data, transmits the encrypted first transmission data to the first transmission media, and transmits the second transmission data to the second transmission media in an unencrypted form. This computer program has the steps of receiving the encrypted first transmission data via the first transmission media and the second transmission data via the second transmission media; decrypting the encrypted first transmission data by use of at least a part of the received second transmission data; and reconfiguring the original transmission data from the decrypted first transmission data and the received second transmission data.

The computer programs of the second and third embodiments define computer programs written in a computer-readable form so as to realize predetermined processing on the computer. In other words, installing the computer programs of the second and third embodiments onto the computer allows cooperative actions on the computer, thereby realizing the communications apparatuses on the transmitting and receiving sides in the communications system practiced as the first embodiment. The transmitting communications apparatus and the receiving communications apparatus execute data transmission by the simultaneous use of the first and second transmission media having different security levels, thereby providing similar functional effects to those of the communications system of the first embodiment.

As described and according to an embodiment, a communications system, a communications apparatus and method, and a computer program are provided that increase the speed of data transmission by the simultaneous use of two or more transmission media.

According to an embodiment, a communications system, a communications apparatus and method, and a computer program are provided that can execute data transmission by the simultaneous use of secure transmission media and insecure transmission media.

According to an embodiment, a communications system, a communications apparatus and method, and a computer program are provided that also securely transmit transmission data distributed to insecure transmission media in the same manner as transmission data distributed to secure transmission media.

Encryption of transmission media requires the sharing of a key between the transmitting side and the receiving side. According to the communications system practiced as one embodiment of the present application, an encryption key is generated from the second transmission data to be transmitted via the second transmission media, so that the user need not execute special operations and methods for key sharing, such as setting key data to both the transmitting and receiving devices in advance.

Further, with the communications system according to an embodiment, the encryption key for encrypting the insecure first transmission media is changed for every transmission packet, if the key for one packet is broken by a brute force attack for example, other packets remain secure, thereby neutralizing such attacks.

Additional features and advantages are described herein, and will be apparent from the following Detailed Description and the figures.

### BRIEF DESCRIPTION OF THE FIGURES

FIG. 1 is a schematic diagram illustrating a configuration of a communications system practiced of an embodiment;

FIG. 2 is a schematic diagram illustrating a manner in which transmission packets are distributed to a wireless transmission path and a power line transmission path for transmission in executing communication between a hybrid network bridge apparatus and a hybrid network bridge apparatus that relay between a server and a communications terminal;

FIG. 3 is a schematic diagram illustrating the division of transmission data in the hybrid network bridge;

FIG. 4 is a schematic diagram illustrating a manner in which transmission data is received via a wireless transmission path and a power line transmission path and the received data is reconfigured;

FIG. 5 is a schematic diagram illustrating a manner in which transmission data is divided when XOR is applied to encryption processing;

FIG. 6 is schematic diagram illustrating a manner in which transmission data is received via the wireless transmission path and the power line transmission path and the received data is reconfigured when XOR is applied to encryption processing;

FIG. 7 is a schematic diagram illustrating an exemplary configuration of a communications system configured to satisfy input data in key generation processing by use of given data;

FIG. 8 is a schematic diagram illustrating an exemplary configuration of a communications system configured to encrypt the wireless transmission path by use of given data as an initialization vector;

FIG. 9A is a schematic diagram illustrating a manner in which same data is encrypted by use of different initialization vectors;

FIG. 9B is another schematic diagram illustrating a manner in which same data is encrypted by use of different initialization vectors;

FIG. 10 is a schematic diagram illustrating a manner in which, in transmitting data by use of a plurality of transmission media, the transmission data is dividedly transmitted to these transmission media and the divided data are reconnected at the reception side;

FIG. 11 is a schematic diagram illustrating a communications method in which packets to be transmitted are sequentially distributed to a plurality of transmission media without dividing packets;

FIG. 12 is a schematic diagram illustrating a manner in which an identifier is attached to data distributed to each transmission media to string encrypted data with information for decrypting the encrypted data;

FIG. 13 is a schematic diagram illustrating an exemplary configuration of a communications system for using the Internet in a home;

FIG. 14 is a schematic diagram illustrating an exemplary configuration of a communications system based on a wireless LAN; and

FIG. 15 is a schematic diagram illustrating an exemplary configuration of a communications system with a part of a wired transmission path between the server and a communications terminal, such as a PC, replaced by a power line transmission path.

### DETAILED DESCRIPTION

This present application will be described in further detail by way of embodiments thereof with reference to the accompanying drawings.

The present application relates to a communications system configured to relay data transmission by use of a power line transmission path between bridge apparatuses. A communications system based on power line communication behaves in accordance with the structure of a house in which communication is made by use of this communications system and susceptible to the noise caused by the living patterns of the family. Therefore, an embodiment of the present application is configured to execute communication between access points by a hybrid network bridge capability in which a bridge apparatus execute relay by hybrid network media made up of a wireless transmission path and a power line transmission path.

For example, Japanese Patent Laid-Open No. 2006-109022 already assigned to the applicant hereof proposes a hybrid communications system configured to use both the wireless transmission path and the power line transmission path and combine these transmission paths or select one thereof to complement each thereof in transmission forms in accordance with communications states, thereby realizing efficient data transmission.

Wireless communication is susceptible to the interference of other systems using the same frequency channel. In addition, the wireless LAN is restricted in transmission output because of the radio frequency control and the avoidance of interference with other systems, for example, thereby presenting problems of limited communication distance and limited room-to-room communication intervened by walls, for example. On the other hand, the power line communication allows room-to-room communication by use of existing facilities, but this form of communication behaves differently depending upon the structure of house and susceptible to the noise caused by living activities (plugging/unplugging of electric cables and turning on/off of dryer, for example).

In contrast, a communications system configured to relay data transmission between bridge apparatuses interconnected by two or more transmission media allows the hybrid network bridges to combine the different transmission media or select one thereof to speed up communication in accordance with the transmission form and communications state, thereby realizing efficient transmission while ensuring communication quality. As compared with the single transmission media mode, dividing transmission data and transmitting the divided transmission data alternately to the wireless transmission path and the power line transmission path by the hybrid network bridge apparatus can enhance communication speed. Therefore, the embodiment is suitably applicable to applications in which mass data is downloaded from a server to an information terminal, for example, or applications that demand isochronization in moving image streaming, for example.

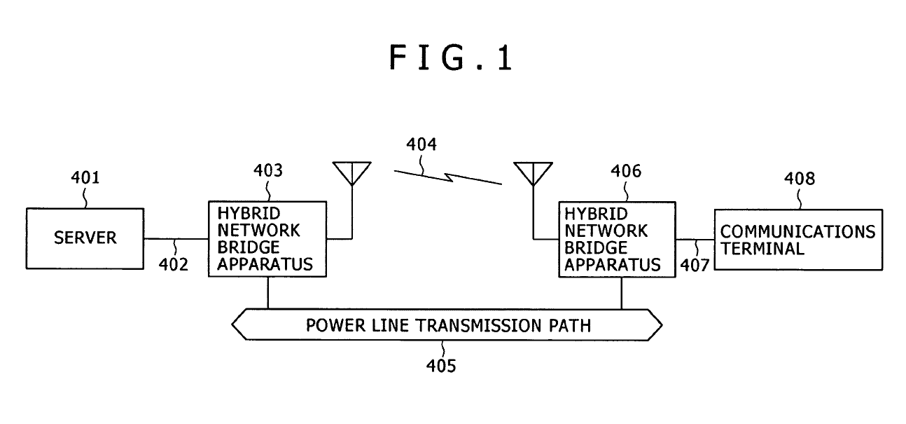

Now, referring to FIG. 1, there is schematically shown a communications system practiced as one embodiment. In the shown system, the PLC bridge apparatuses in the communications system shown in FIG. 15 are replaced by a hybrid network bridge apparatus 403 and a hybrid network bridge apparatus 406 each having a PLC interface and a wireless LAN interface. It should be noted that there is no restriction on the specific frequency of the wireless transmission path; however, if a standard wireless LAN standard, such as IEEE 802.11a/g, is followed, it is possible to use 2.4 GHz band or 5 GHz band, while frequency bands of short wave, namely, 3 MHz to 30 MHz, are generally used with the power line transmission media

The hybrid network bridge apparatus 403 is connected with a server 401, a source of information provision, via a wired transmission path 402, such as Ethernet (registered trademark), and with the hybrid network bridge apparatus 406 via a hybrid transmission media made up of a wireless transmission path 404 and a power line transmission path 405 for the communication between access points, the hybrid network bridge apparatus 406 relays the transmission to a communications terminal 408, an information request source, such as a PC at the end of path, via a wired transmission path 407.

The communications system shown in FIG. 1 can be applied to a configuration in which, in a home for example, the hybrid network bridge apparatus 403 having a connection point with the Internet is arranged on the first floor and the hybrid network bridge apparatus 406 is arranged on the second floor, for example, thereby allowing the Internet connection also from the communications terminal 408 arranged also on the second floor.

In the communications system shown, in transmitting data from the server 401 to the communications terminal 408, the data is transmitted to the hybrid network bridge apparatus 403 first passing the wired transmission path 402, such as Ethernet (registered trademark).

In transferring packets of reception data to the hybrid network bridge apparatus 406, the hybrid network bridge apparatus 403 either selects one of a wireless transmission path 404 and a power line transmission path 405 or divides the transmission data to distribute the divided transmission data to both the media. Next, the hybrid network bridge apparatus 406 transmits the received data to the communications terminal 408 via the wired transmission path 407. In the following description, the hybrid network bridge apparatus 403 divides the transmission data received from the server 401 and distributes the divided data to both the media for transmission and the mate hybrid network bridge apparatus 406 reconfigures the divided data.

It should be noted that, in the embodiment shown in FIG. 1, data is relayed to hybrid network media by use of the hybrid network bridge apparatus 403 and the hybrid network bridge apparatus 406; it is also practicable to incorporate the hybrid network bridge capabilities into a host device, such as the server 401 or the communications terminal 408.

In the embodiment shown in FIG. 1, the hybrid network bridge apparatus 403 and the hybrid network bridge apparatus 406 are interconnected with two media; however, it is also practicable to interconnect the bridge apparatuses with n (an integer of 3 or more) media as a variation to the embodiment. In this case, the hybrid network bridge apparatus 403 divides transmission data by n and distributes the divided transmission data to the n media for transmission, the data thus transmitted being reconfigured by the mate hybrid network bridge apparatus 406.

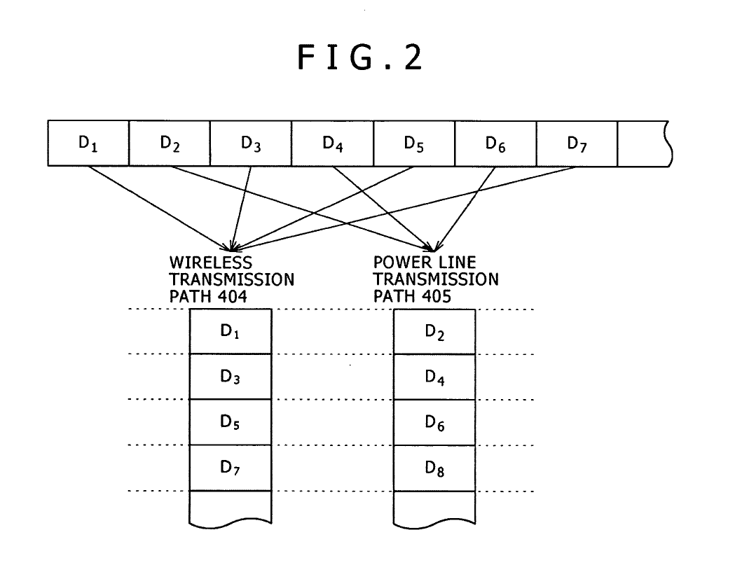

FIG. 2 shows a manner in which, in executing communication between the hybrid network bridge apparatus 403 and the hybrid network bridge apparatus 406 for relaying between the server 401 and the communications terminal 408, transmission packets are distributed to the wireless transmission path and the power line transmission path for transmission.

In FIG. 2, D₁, D₂, D₃, and so on are transmission packets, these numbers being indicative of a sequence in an original transmission stream. As shown, the divided transmission data are alternately distributed to the wireless transmission path 404 and the power line transmission path 405, so that the communication speed is enhanced as compared with the transmission based on only one transmission media. Hence, the present embodiment is suitable for applications in which in which mass data is downloaded from a server to an information terminal, for example, or applications that demand isochronization in moving image streaming, for example.

The hybrid network bridge apparatus 403 on the transmission side uses a fragmentation capability of dividing IP packets specified by the Internet protocol (IP), for example, to distribute the IP packets to both media on the wireless transmission path 404 and the power line transmission path 405, thereby executing efficient data transmission. On the other hand, the hybrid network bridge apparatus 406 or the communications terminal 408 on the reception side defragments (or reconfigures) the received fragmented IP packets.

The fragmentation capability denotes that, originally, in transferring IP packets in a communication device, such as a router, if the length of IP packet to be transferred is greater than MTU (Maximum Transfer Unit) of a transfer destination network, the IP packet is divided smaller than the size of MTU for transfer.

Meanwhile, data communication is typically exposed to a danger of data interception by a third party, so that security measures have to be taken to prevent this data interception from happening. The security levels depend on transmission media, requiring different security measures. In the communications system shown in FIG. 1, encryption is demanded on the wireless transmission path 404 but not demanded on the power line transmission path 405.

The following describes a case in which data is transmitted from the server 401 to the communications terminal 408.

First, the data transmitted from the server 401 reaches the hybrid network bridge apparatus 403 via the wired transmission path 402.

The hybrid network bridge apparatus 403 transmits the received data to the wireless transmission path 404 and the power line transmission path 405. The hybrid network bridge apparatus 403 may divide one packet of received data by means of the fragmentation capability for example to distribute the divided packet to the wireless transmission path 404 and the power line transmission path 405 or distribute one packet of received data alternately to the wireless transmission path 404 and the power line transmission path 405 without division. The following describes a case in which the hybrid network bridge apparatus 403 divides packets to distribute the divided packets to the wireless transmission path 404 and the power line transmission path 405 for transmission.

In dividing packets, the division is made properly in accordance with the quality of transmission media, for example, (refer to Patent Document 3 for example).

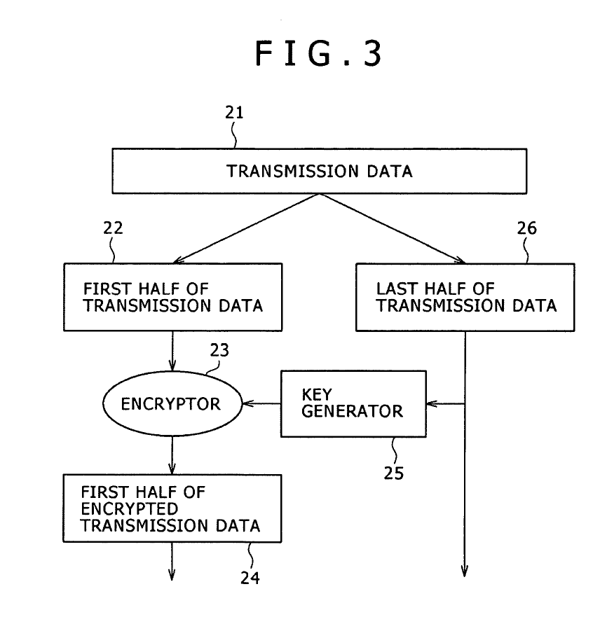

FIG. 3 shows a manner in which transmission data is divided by the hybrid network bridge apparatus 403. As shown, transmission data 21 is divided into first half of transmission data 22 and last half of transmission data 26 to be transmitted to the wireless transmission path 404 and the power line transmission path 405, respectively.

The first half of the transmission data 22 to be transmitted to the wireless transmission path 404 need to be encrypted. Therefore, first, a key generator 25 generates an encryption key by use of the last half of transmission data 26.

Any algorithm may he used for generating the encryption key. It should be noted, however, that the receiving side (the hybrid network bridge apparatus 406 or the communications terminal 408) has to use the same algorithm as that used by the transmitting side.

With a comparatively simple key generating algorithm, a part from the beginning of the last half of transmission data 26 is taken in a wide equivalent to key size and this part is used as an encryption key. Other algorithms include the MD (Message Digest) 5 algorithm specified in RFC (Request for Comments) 1321. In this algorithm, with the last half of transmission data 26 as an input of the same algorithm, data equivalent to a predetermined key size can be obtained.

The encryptor 23 uses the encryption key thus generated to encrypt the first half of transmission data 22, getting first half of encrypted transmission data 24.

Any algorithm may be used for encryption processing by the encryptor 23. For example, AES (Advanced Encryption Standard) that is a common key encryption algorithm may be used. However, the receiving side has to use the same algorithm as that of the transmitting side (the hybrid network bridge apparatus 406 or the communications terminal 408).

Thus, the first half of encrypted transmission data 24 is transmitted to the wireless transmission path 404 that is lower in security and the last half of transmission data 26 is transmitted unencrypted to the power line transmission path 405 that is higher in security.

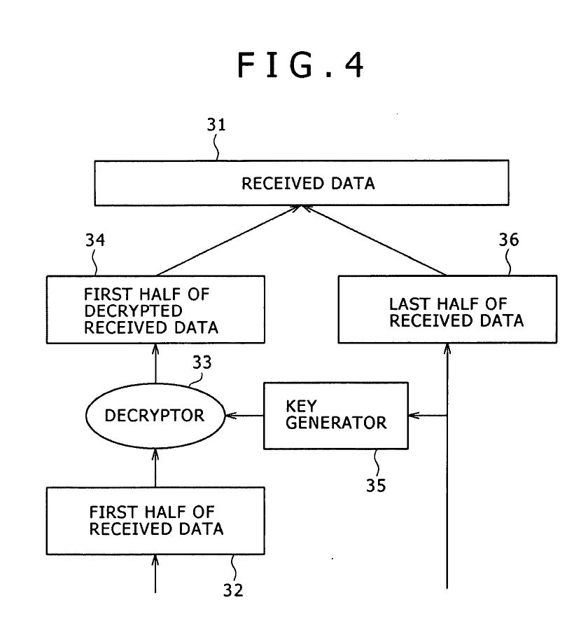

FIG. 4 shows a manner in which the receiving side receives the transmission data via the wireless transmission path 404 and the power line transmission path 405 to reconfigure the received divided data. It is assumed here that the hybrid network bridge apparatus 406 execute data decryption processing.

As described above, the last half of received data 36 via the power line transmission path 405 is not encrypted, but the first half of the received data 32 via the wireless transmission path 404 is encrypted, so that this encrypted data has to be decrypted.

The key for decryption has to be the same as the key used for encryption in the hybrid network bridge apparatus 403. Therefore, a key generator 35 generates a key from the last half of received data 36 For example, data equivalent to key size is taken from the beginning of the last half of received data 36 to generate a decryption key or data equivalent to the last half of received data 36 is used to generate a decryption key by use of the MD5 algorithm as described above.

Then, a decryptor 33 decrypts the first half of received data 32 by use of the decryption key generated as described above to provide the first half of decrypted received data 34. Any algorithm may be used for the decryption processing by the decryptor 33. However, this algorithm has to be the same as that used in the hybrid network bridge apparatus 403.

When the first half of decrypted received data 34 is obtained by the decryption processing, received data 31 can be reconfigured together with the last half of received data 36.

The hybrid network bridge apparatus 406 transmits the data reconfigured as described above to the communications terminal 408 via the wired transmission path 407.

In the configuration examples shown in FIGS. 3 and 4, the keys for use in encryption and decryption are generated by the key generator 25 and the key generator 35; however, it is also practicable to further simplify the encryption and decryption processing.

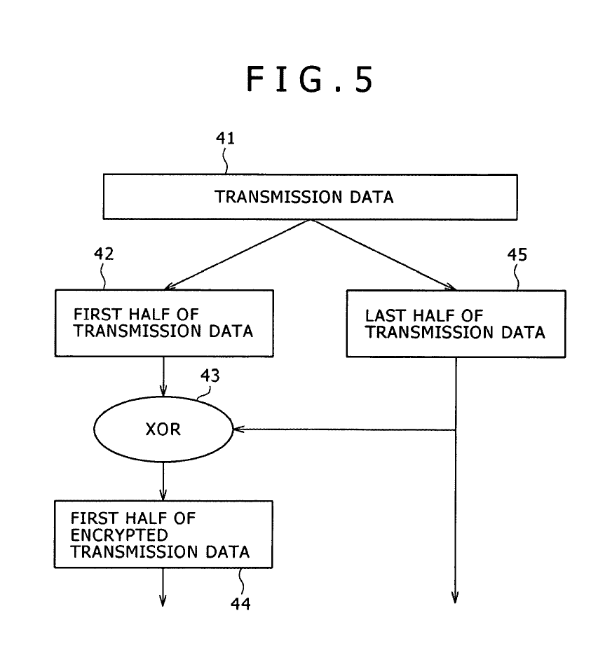

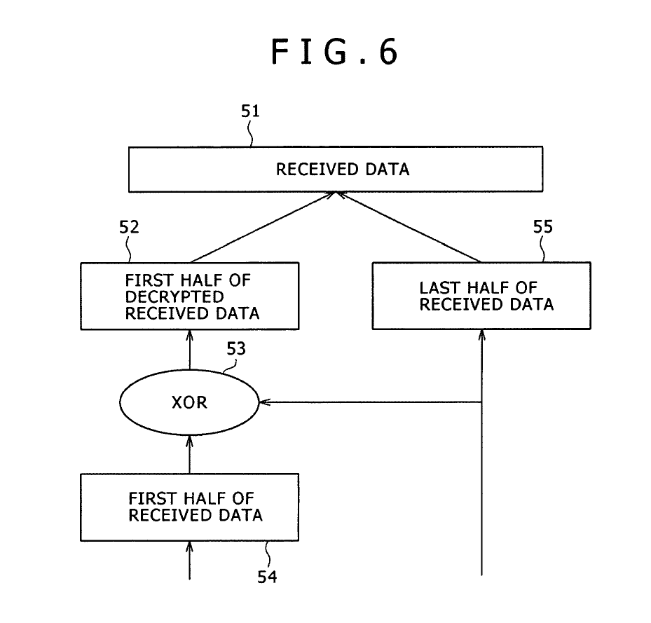

For example, rather than generating the encryption key by use of the last half of transmission data as described above, an exclusive OR operation (XOR) can be executed between the transmission data first half and the last half thereof, thereby encrypting the first half of the transmission data in a simplified manner. In this case, the receiving side can execute an exclusive OR operation between the first half of the encrypted received data and the last half thereof to decrypt the received encrypted data. FIGS. 5 and 6 show manners in which the transmission data is divided and the divided received data are reconfigured when exclusive OR operations are executed for encryption and description.

To be more specific, transmission data 41 is divided into a first half of transmission data 42 and a last half of transmission data 45, the first half being transmitted to the wireless transmission path 404 and the last half to the power line transmission path 405. At this moment, the first half of transmission data 42 to be transmitted to the wireless transmission path 404 has to be encrypted, so that an exclusive OR operation is executed with the last half of transmission data 45 in an XOR 43 for encryption. Next, the first half of encrypted transmission data 44 is transmitted to the wireless transmission path 404 that is lower in security level and the last half of transmission data 45 that is not encrypted is transmitted to the power line transmission path 405 that is higher in security level.

On the other hand, on the receiving side, the last half of received data 55 via the power line transmission path 405 is not encrypted but the first half of received data 54 via the wireless transmission path 404 is encrypted, so that this first half of received data 54 has to be decrypted. Therefore, an exclusive OR operation is executed with the last half of received data 55 in an XOR 53 for encryption processing. Because the last half of transmission data 45 is not encrypted, namely, the last half of transmission data 45=the last half of reception data 55, it can be understood that the original first half of transmission data 42 is obtained by executing an exclusive OR operation as shown an equation below.

The first half of transmission data 42 XOR the last half of transmission data XOR the last half of received data 55=the first half of transmission data 42 XOR 0=the first half of transmission data 42

When the first half of decrypted received data 52 is obtained by the decryption processing, received data 51 can be reconfigured together with the last half of received data 56. Then, the hybrid network bridge apparatus 406 transmits the reconfigured data to the communications terminal 408 via the wired transmission path 407.

According to the transmission/reception system configuration shown in FIGS. 5 and 6, no complicated encryption/decryption processing is demanded to protect the security of the data to be transmitted via the wireless transmission path 404. Namely, instead of using the encryption processing, such as AES, exclusive OR operations can be executed to execute encryption processing with a relatively small computation amount. Consequently, the novel configuration provide applications for incorporated devices, for example, having limited computation power.

In the description made so far, the data length associated with the division of transmission data at the transmitting side has not especially been mentioned. The present application is applicable independently of the data lengths of the first half and last half of transmission data.

For example, Japanese Patent Laid-Open No. 2006-109022 discloses, in a communications system based on hybrid network media made up of wireless communication and power line transmission, the distribution of transmission data to each transmission media such that the divided data is transmitted in substantially and equal time length. Let the number of bits associated with a demodulation scheme for demodulating the first half and last half of transmission data be m1 and m2 and coding ratios of the transmission media be r1 and r2, then dividing data in accordance with the following ratio and distributing the divided data to the transmission media make the transmission times of both equal:

m1×r1: m2×r2

The strength of security in the encrypted wireless transmission path 404 generally depends on the length of input data into a key generator that generates encryption keys. However, if a scheme for controlling the ratio between the first half and the last half of transmission data as described above is used, the data length of the last half of transmission data becomes short depending on a difference in communication quality between the transmission media, thereby making it possible that a data length necessary for obtaining strong enough encryption keys in the key generator may not be reached.

Therefore, at the transmitting side, given data may be added to the last half of transmission data to get a length necessary for the input into the key generator to have an enough strength.

The transmitting side may generate this given data by any means. The given data used for supplementing the length of input data is also requisite for generating a decryption key for decrypting the encrypted data at the receiving side. The given data generated by the transmitting side can be transmitted to the receiving side via the secure power line transmission path 405, thereby preventing the security of the encrypted wireless transmission path 404 from being lost.

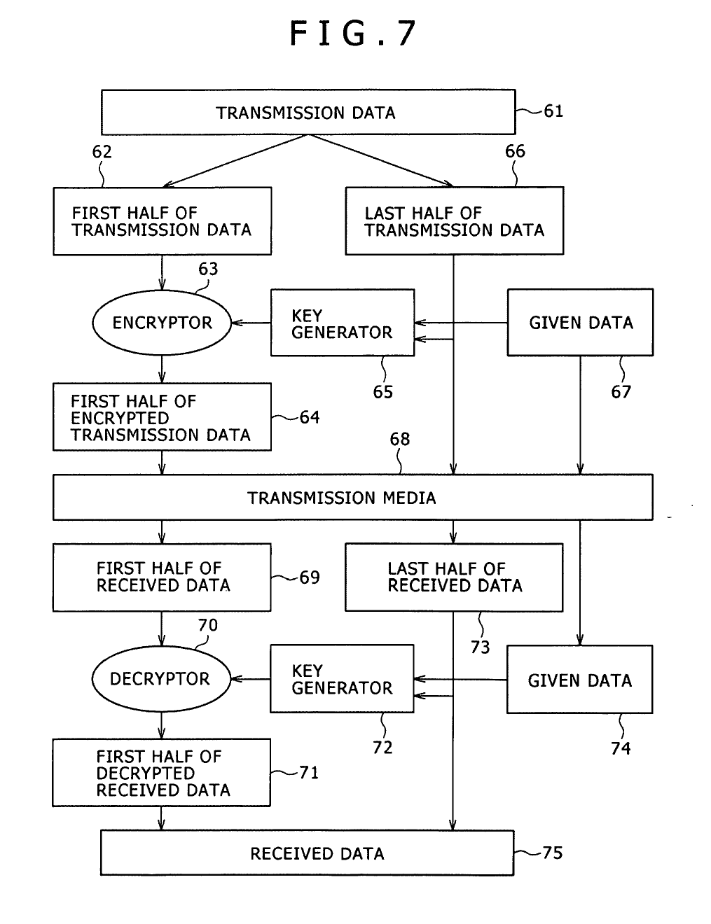

FIG. 7 shows an exemplary configuration of a communications system configured to supplement the input data in key generation processing by use of given data.

At the transmitting side, a first half of original transmission data 61 is transmitted to the wireless transmission path 404 and the last half to the power line transmission path 405. At this moment, first half of transmission data 62 to be transmitted to the wireless transmission path 404 that is lower in security level has to be encrypted. A key generator 65 generates encryption keys by use of the last half of transmission data 66; however, this input data is not long enough for strong enough security. Therefore, the transmitting side generates given data 67 and enters this given data into the key generator 65 to generate an encryption key. Any algorithm may be used for generating the encryption key, but the algorithm used has to be the same as that of the receiving side as described above.

By use of the encryption key thus generated, an encryptor 63 encrypts the first half of transmission data 62 to get the first half of encrypted transmission data 64. Any encryption algorithm may be used, but the encryption algorithm used has to be the same as that of the receiving side as described above.

Thus, the first half of encrypted transmission data 64 is transmitted to the wireless transmission path 404 that is lower in security level and the last half of transmission data 66 is transmitted unencrypted to the power line transmission path 405 that is higher in security level. Given data 67 used for supplementing the length of input data is also demanded to generate a decryption key for decrypting the encrypted received data at the receiving side, so that the given data is transmitted to the receiving side via the power line transmission path 405 without change.

On the other hand, the last half of received data received 73 via the power line transmission path 405 is not encrypted but the first half of received data 69 received via the wireless transmission path 404 is encrypted, so that the receiving side has to decrypt this encrypted first half of received data 69.

The key for use in decryption has to be the same key as used for encryption in the hybrid network bridge apparatus 403. Therefore, a key generator 72 generates a decryption key by use of the last half of received data 73 received via the power line transmission path 405 and given data 74 received via the power line transmission path 405.

By use the decryption key thus generated, a decryptor 70 decrypts the first half of received data 69 to get first half of decrypted received data 71. Then, the received data 75 can be reconfigured together with the last half of received data 73. The hybrid network bridge apparatus 406 transmits the reconfigured data to the communications terminal 408 via the wired transmission path 407.

In the description made so far, the secrecy to be protected when same data continues has not especially been referred to. If same data continues, the possibility of guessing the encryption key used to encrypt that data becomes high, presenting a danger of weakening the encrypted transmission media. Therefore, a method is proposed in which given data generated by the transmitting side is used not as the supplement to the length of input data into the key generator as described above, but as an initialization vector for initializing the encryption processing.

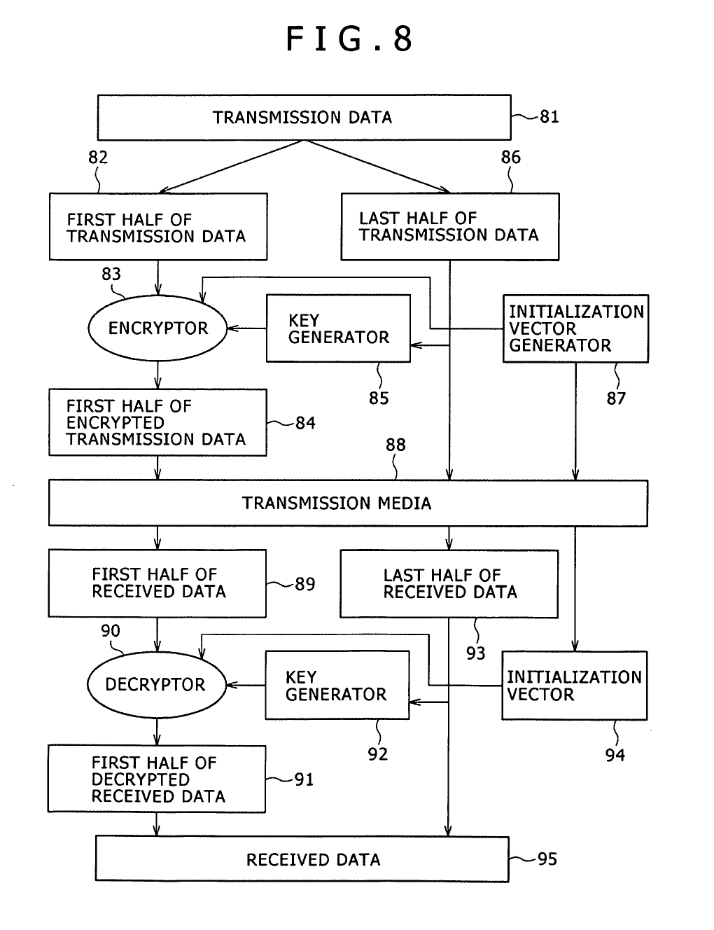

FIG. 8 shows an exemplary configuration of a communications system configured to encrypt the wireless transmission path 404 by use of given data as an initialization vector.

The transmitting side divides original transmission data 81 and transmits a resultant first half 82 to the wireless transmission path 404 and a resultant last half 86 to the power line transmission path 405. In doing so, it is demanded to encrypt the first half of transmission data 82 that is transmitted to the wireless transmission path 404 that is lower in security level.

A key generator 85 generates an encryption key by use of at least a part of the last half of transmission data 86. Any algorithm may be used to generate encryption keys, but the encryption algorithm used has to be the same as that of the receiving side as described above. An initialization vector generator 87 generates initialization vectors by use of a given method.

The encryptor 83 initializes the encryption processing and, by use of an encryption key obtained from the last half of transmission data 86, encrypts the first half of transmission data 82 to obtain the first half of encrypted transmission data 84. Any algorithm may be used for the encryption processing, but the encryption algorithm used has to be the same as that of the receiving side as described above.

Thus, to the wireless transmission path 404 that is lower in security level, the first half of encrypted transmission data 84 is transmitted, while, to the power line transmission path 405 that is higher in security level, the last half of transmission data 86 is transmitted unencrypted. The initialization vector 94 is also demanded for generating an encryption key to be used by the receiving side for decryption, so that the initialization vector is transmitted to the secure power line transmission path 405 to the receiving side in an unencrypted form.

On the other hand, the receiving side has to decrypt the first half of received data 89 via the wireless transmission path 404, although the last half of received data 93 via the power line transmission path 405 need not be decrypted because this data is not encrypted.

A key for use in decryption has to be the same as that used by the hybrid network bridge apparatus 403 on the transmitting side for encryption. Therefore, a key generator 92 generates a decryption key by use of the last half of the received data 73 via the power line transmission path 405.

A decryptor 90 initializes the encryption processing by use of an initialization vector 94 received via the power line transmission path 405 and then uses a decryption key obtained from the last half of received data 93 to decrypt the first half of received data 89, thereby getting a first half of decrypted received data 91. Then, received data 95 can be reconfigured together with the last half of received data 93. Having reconfigured the data, the hybrid network bridge apparatus 406 transmits the reconfigured data to the communications terminal 408 via the wired transmission path 407.

Mainly with block cryptography, for example, a technique is used in which data interception is made difficult by encrypting data by use of the cipher text of the immediately preceding block. Because there is no immediately preceding block for the head block, a random bit sequence having an appropriate length for the immediately preceding block is an initialization vector.

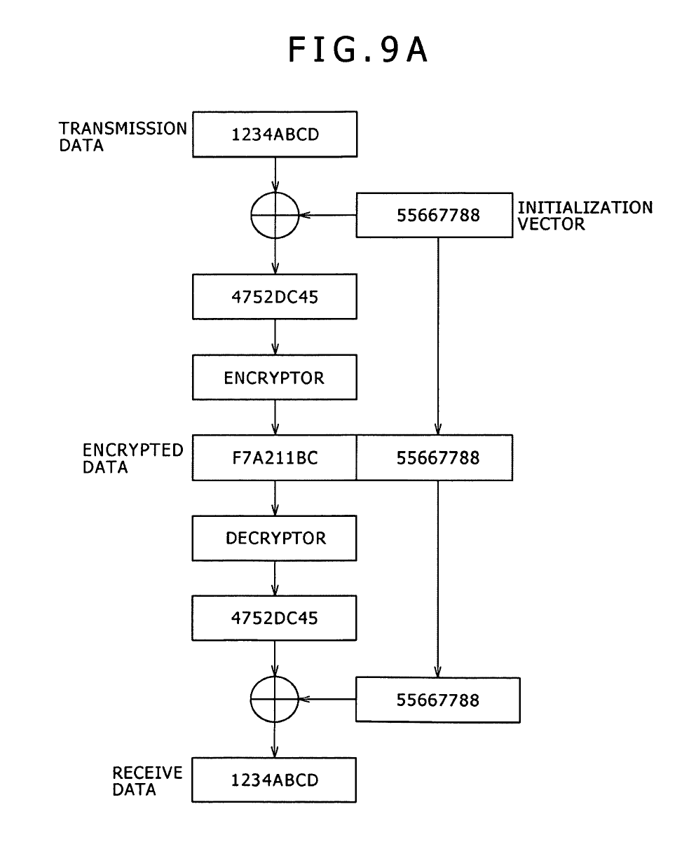

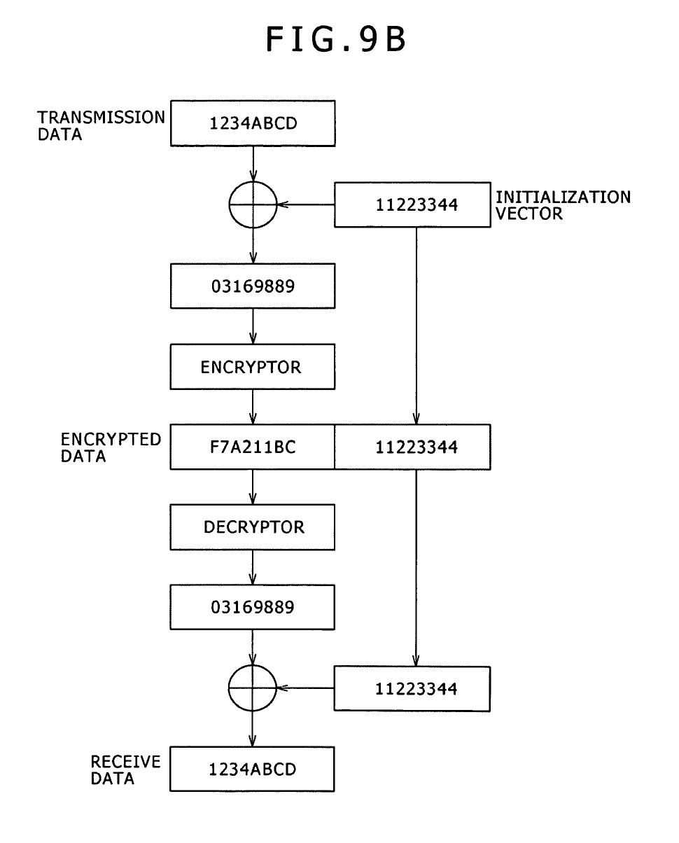

FIGS. 9A and 9B show a manner in which encryption processing is, executed on same data by use of different initialization vectors. Comparison of these figures indicates that, because use of different initialization vectors can obtain different encryption keys from same input data, if same transmission data is encrypted with a same encryption algorithm, different encrypted data is generated. Further, by use of initialization vectors used for encryption, decryption can be executed with a same algorithm as that used in encryption processing, thereby reproducing the same original data even if encrypted data is different.

In the communications system practiced as the present embodiment, the encryption keys for encrypting the wireless transmission path 404 that is not secure are changed for every packet, so that cipher breaking techniques, such as a round-robin algorithm, can be made difficult to execute. Further, appropriately switching between initialization vectors can make it more difficult to break cryptography, thereby ensuring secrecy if same data continues.

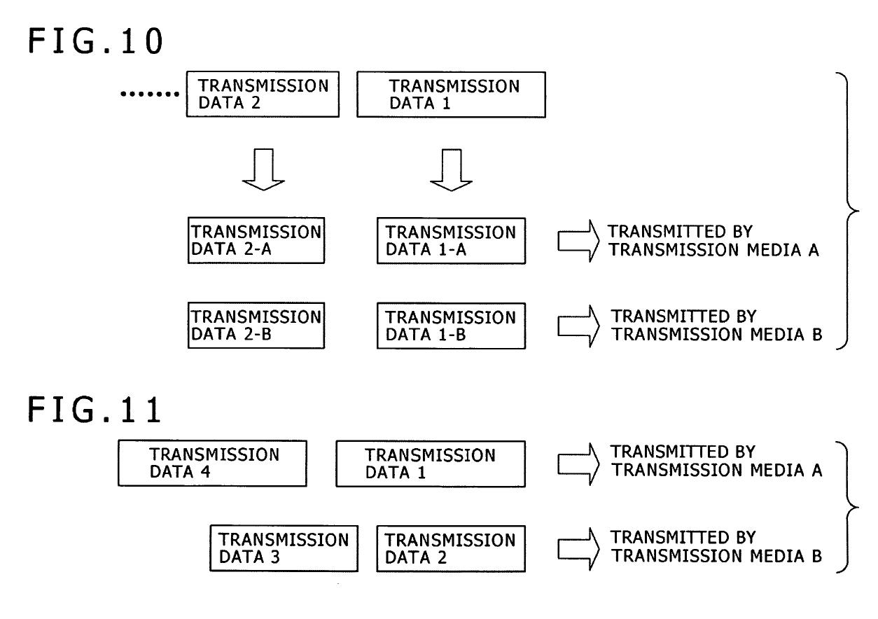

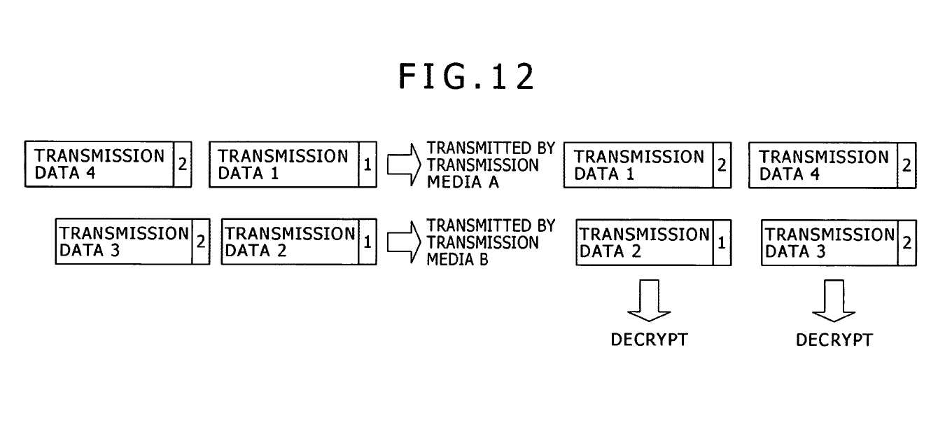

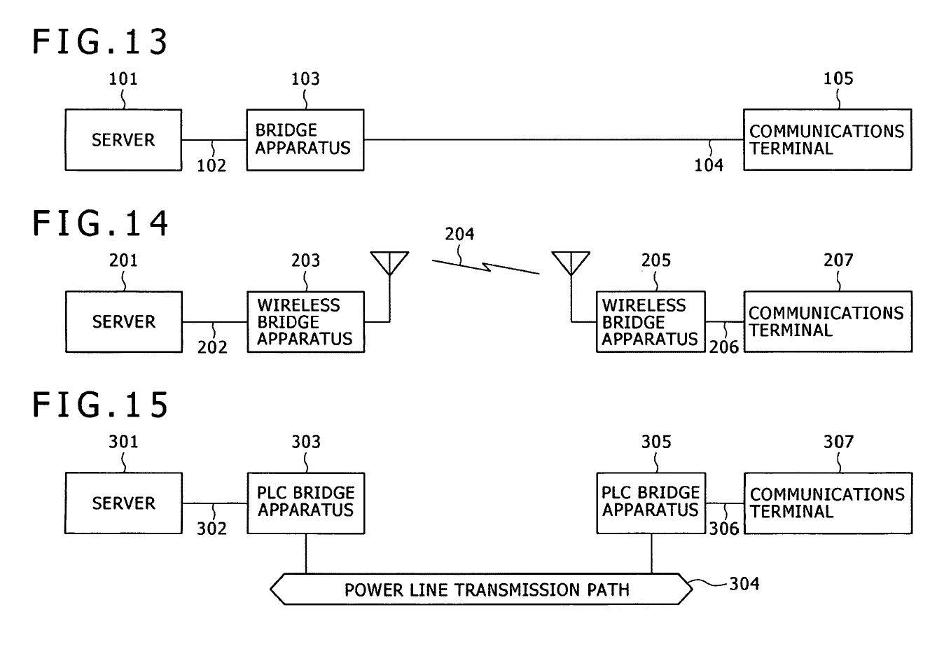

It should be noted that, in the description made so far, it is assumed as shown in FIG. 10 that, in transmitting data by use of two or more transmission media, transmission data is divided to be transmitted to these transmission media and the divided data are linked again at the receiving side. However, as shown in FIG. 11, the present embodiment is also applicable to a communications system shown in FIG. 11 in which packets are not divided but sequentially distributed to two or more transmission media for transmission. In the case of the latter, however, it is necessary to link the encrypted data with the information for decrypting the encrypted data. This can be realized by attaching an identifier to each piece of encrypted data on the receiving side (refer to FIG. 12).

While preferred embodiments of the present application have been described using specific terms, such description is for illustrative purpose only, and it should be understood that suitable modification thereof can be made.

As discussed above, communications systems practiced as an embodiment in which data transmission is executed via hybrid network media made up of a wireless transmission path and a power line transmission path have mainly described herein. However, the present application is not restricted thereto. For example, the present application is also applicable to communications systems that use various hybrid network media made up of combinations of transmission media some of which need encryption while others need not encryption.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A communications system configured to execute data transmission by use of a first transmission media and a second transmission media that are different from each other in security level, the communication system comprising:
a communications apparatus on a transmitting side dividing transmission data into first transmission data and second transmission data that are transmitted via said first transmission media and said second transmission media, respectively, encrypting said first transmission data by use of at least a part of said second transmission data, transmitting the encrypted first transmission data to said first transmission media, and transmitting said second transmission data to said second transmission media in an unencrypted form; and
a communications apparatus on a receiving side receiving said encrypted first transmission data via said first transmission media, receiving said second transmission data via said second transmission media, decrypting the encrypted first transmission data by use of at least a part of said second transmission data, and reconfiguring original transmission data from said first transmission data and said second transmission data.

2. The communications system according to claim 1, wherein said communications apparatus on the transmitting side generates an encryption key by use of at least a part of said second transmission data and encrypts said first transmission data by use of the generated encryption key, and
the communication apparatus on the receiving side generates a decryption key by use of at least a part of said second transmission data received via said second transmission media in accordance with a same key generating algorithm as that used b) the communications apparatus on the transmitting side and decrypts said encrypted first transmission data received via said first transmission media by use of said decryption key in accordance with a same encryption processing algorithm as that used by the communications apparatus on the transmitting side.

3. The communications system according to claim 1, wherein said communications apparatus on the transmitting side decrypts said first transmission data by executing an exclusive OR operation with at least a part of said second transmission data, transmits the encrypted first transmission data to said first transmission media, and transmits said second transmission data to said second transmission media in an unencrypted form; and
said communications apparatus on the receiving side decrypts the encrypted first transmission data received via said first transmission media by executing an exclusive OR operation with at least a part of said second transmission data received via said second transmission media.

4. The communications system according to claim 2, wherein said communications apparatus on the transmitting side generates an encryption key on the basis of data long enough configured by adding given data to said second transmission data, encrypts said first transmission data by use of the generated encryption key, transmits the encrypted first transmission data to said first transmission media, and transmits said second transmission data to said second transmission, media in an unencrypted form, and transmits said given data to said second transmission media, and
said communications apparatus on the receiving side receives said encrypted first transmission data via the first transmission media, receives said second transmission data and said given data via said second transmission media, generates a decryption key on the basis of data configured by adding given data to said second transmission data and decrypts said encrypted first transmission data received via said first transmission media by use the of the generated decryption key.

5. The communications system according to claim 2, wherein the communication apparatus on the transmitting side generates an encryption key by use of at least a part of said second transmission data, generates an initialization vector, initializes the encryption processing by use of the generated initialization vector, then encrypts said first transmission data by use of the generated encryption key, transmits the encrypted first transmission data to said first transmission media, transmits said second transmission data to the second transmission media in an unencrypted form, and transmits said initialization vector to said second transmission media, and
said communications apparatus on the receiving side receives said encrypted first transmission data via said first transmission media, receives said second transmission data and said initialization vector via said second transmission media, generates a decryption key by use of at least a part of said second transmission data received via said second transmission media, initializes the encryption processing by use of said initialization vector, and then decrypts the encrypted first transmission data by use of said decryption key.

6. A communications apparatus configured to transmit data to a first transmission media and a second transmission media that are different from each other in security, level, the communications apparatus comprising:
data distributing means for distributing transmission data to first transmission data and second transmission data to be transmitted via said first transmission media and said second transmission media;
encryption processing means for encrypting said first transmission data by use of at least a part of said second transmission data; and
data transmitting means for transmitting the encrypted first transmission data to said first transmission media and transmit said second transmission data to said second transmission media in an encrypted form.

7. The communications apparatus according to claim 6, further comprising
key generating means for generating an encryption key by use of at least part of said second transmission data, wherein
said encryption processing means encrypts said first transmission data by use of the generated encryption key.

8. The communications apparatus according to claim 6, wherein said encryption processing means encrypts said first transmission data by execute an exclusive OR operation with at least a part of said second transmission data.

9. The communications apparatus according to claim 7, further comprising
given data generating means for generating given data, wherein
said key generating means generates an encryption key on the basis of data long enough configured by adding said given data to said second transmission data, and
said encryption processing means encrypts said first transmission data by use of the generated encryption key.

10. The communications apparatus according to claim 7, further comprising
initialization vector generating means for generating an initialization vector, wherein
said key generating means generates an encryption key by use of at least a part of said second transmission data, and
said encryption processing means initializes encryption processing by use of said initialization vector and then encrypts said first transmission data by use of the generated encryption key.

11. A communications apparatus configured to receive data via first transmission media and a second transmission media that are different from each other in security level, the communications apparatus comprising:
a communications apparatus on a transmitting side dividing transmission data into first transmission data and second transmission data to be transmitted via said first transmission media and said second transmission media, respectively, encrypting said first transmission data by use of at least a part of said second transmission data, transmitting the encrypted first transmission data to said first transmission media, and transmitting said second transmission data to said second transmission media in an unencrypted form, comprising:
data receiving means for receiving said encrypted first transmission data via said first transmission media and said second transmission data via said second transmission media,
decryption processing means for decrypting the encrypted first transmission data by use of at least a part of the received second transmission data, and
data reconfigurating means for reconfiguring the original transmission data from the decrypted first transmission data and the received second transmission data.

12. The communications apparatus according to claim 11, wherein an encryption key is generated by use of at least a part of said second transmission data and said first transmission data is encrypted by use of the generated encryption key, further comprising
key generating means for generating a decryption key by use of at least a part of said second transmission data received via said second transmission media in accordance with a same key generating algorithm as that of said communications apparatus on the transmitting side,
said decryption processing means decrypting the encrypted first transmission data received via said first transmission media by use of a same encryption processing algorithm as that of said communications apparatus on the transmitting side.

13. The communications apparatus according to claim 11, wherein said communications apparatus on the transmitting side encrypts said first transmission data by executing an exclusive OR operation with at least a part of said second transmission data, transmits the encrypted first transmission data to said first transmission media, and transmits said second transmission data to said second transmission media in an unencrypted form, and
said decryption processing means decrypts the encrypted first transmission data received via said first transmission media by executing an exclusive OR operation with at least a part of said second transmission data received via said second transmission media.

14. The communications apparatus according to claim 12, wherein said communications apparatus on the transmitting side generates an encryption key on the basis of data long enough configured by adding given data to said second transmission data, decrypts said first transmission data by use of the generated encryption key, transmits the encrypted first transmission data to said first transmission media, transmits said second transmission data to said second transmission media in an unencrypted form, and transmits said given data to said second transmission media,
said data receiving means further receives said given data via said second transmission media,
said key generating means generates a decryption key on the basis of data configured by adding said given data to the received second transmission data, and
said decryption processing means decrypts the encrypted first transmission data received via the first transmission media by use of the generated decryption key.

15. The communications apparatus according to claim 12, wherein said communications apparatus on the transmitting side generates an encryption key by use of at least a part of said second transmission data, generates an initialization vector, encrypts said first transmission data by use of the generated encryption key after initializing the encryption processing by use of the generated initialization vector, transmits the encrypted first transmission data to said first transmission media, transmits said second transmission data to said second transmission media in an unencrypted form, and transmits said initialization vector to said second transmission media,
said data receiving means further receives said initialization vector via said second transmission media
said key generating means generates a decryption key by use of at least a part of said second transmission data received via said second transmission media, and
said decryption processing means decrypts the encrypted first transmission data by use of the generated decryption key after initializing the encryption processing by use of said initialization vector.

16. A communications method configured to transmit data to a first transmission media and a second transmission media that are different from each other in security level, comprising:
distributing transmission data to first transmission data and second transmission data to be transmitted via said first transmission media and said second transmission media;
encrypting said first transmission data by use of at least a part of said second transmission data; and
transmitting the encrypted first transmission data to said first transmission media and transmit said second transmission data to said second transmission media in an encrypted form.

17. A communications method configured to receive data via a first transmission media and a second transmission media that are different from each other in security level, wherein a communications apparatus on a transmitting side divides transmission data into first transmission data and second transmission data to be transmitted via said first transmission media and said second transmission media, respectively, encrypts said first transmission data by use of at least a part of said second transmission data, transmits the encrypted first transmission data to said first transmission media, and transmits said second transmission data to said second transmission media in an unencrypted form, said communication method comprising:
receiving said encrypted first transmission data via said first transmission media and said second transmission data via said second transmission media;
decrypting the encrypted first transmission data by use of at least a part of the received second transmission data; and
reconfiguring the original transmission data from the decrypted first transmission data and the received second transmission data.

18. A computer program written in a computer-readable form so as to execute, on a computer, processing of transmission of data to a first transmission media and a second transmission media that are different from each other in security level, comprising the steps of:
distributing transmission data to first transmission data and second transmission data to be transmitted via said first transmission media and said second transmission media;
encrypting said first transmission data by use of at least a part of said second transmission data; and
transmitting the encrypted first transmission data to said first transmission media and transmit said second transmission data to said second transmission media in an encrypted form.

19. A computer program written in a computer-readable form so as to execute, on a computer, processing of transmission of data to a first transmission media and a second transmission media that are different from each other in security level, wherein a communications apparatus on a transmitting side divides transmission data into first transmission data and second transmission data to be transmitted via said first transmission media and said second transmission media, respectively, encrypts said first transmission data by use of at least a part of said second transmission data, transmits the encrypted first transmission data to said first transmission media, and transmits said second transmission data to said second transmission media in an unencrypted form, said computer program comprising the steps of:
receiving said encrypted first transmission data via said first transmission media and said second transmission data via said second transmission media;
decrypting the encrypted first transmission data by use of at least a part of the received second transmission data; and
reconfiguring the original transmission data from the decrypted first transmission data and the received second transmission data.

20. A communications apparatus configured to transmit data to a first transmission media and a second transmission media that are different from each other in security level, comprising:
a data distributor configured to distribute transmission data to first transmission data and second transmission data to be transmitted via said first transmission media and said second transmission media;
a encryption processor configured to encrypt said first transmission data by use of at least a part of said second transmission data; and
a data transmitter configured to transmit the encrypted first transmission data to said first transmission media and transmit said second transmission data to said second transmission media in an encrypted form.

21. A communications apparatus configured to receive data via first transmission media and a second transmission media that are different from each other in security level the communications apparatus comprising:
a first communications apparatus on a transmitting side dividing transmission data into first transmission data and second transmission data to be transmitted via said first transmission media and said second transmission media, respectively, encrypting said first transmission data by use of at least a part of said second transmission data, transmitting the encrypted first transmission data to said first transmission media, and transmitting said second transmission data to said second transmission media in an unencrypted form, comprising:
a data receiver configured to receive said encrypted first transmission data via said first transmission media and said second transmission data via said second transmission media:
a decryption processor configured to decrypt the encrypted first transmission data by use of at least a part of the received second transmission data; and
a data reconfigurator configured to reconfigure the original transmission data from the decrypted first transmission data and the received second transmission data.
